(19) United States
(12) Patent Application Publication
(10) Pub. No.: US 2004/0245057 A1
(43) Pub. Date: Dec. 9, 2004

(54) Control device for a parking brake

(76) Inventor: Philippe Bejot, Paris (FR)

Correspondence Address: Leo H McCormick Jr, 2112 Mishawaka Avenue, PO Box 4721, South Bend, IN, 46634-4721, US

(21) Appl. No.: 10/492,650

(22) PCT Filed: Oct. 11, 2002
(86) PCT No.: PCT/FR02/03493

(30) Foreign Application Priority Data
Oct. 17, 2001 (FR) 01/13547

(51) Int. Cl. B60T 13/04

(52) U.S. Cl. 188/167

(57) ABSTRACT

A cable (22) for connecting connecting an operating lever (20) to a disc brake (12), and mechanical-energy accumulation means (28), which are separate from the cable (22) and which connect a proximal strand (22P) to a distal strand (22D) of the cable. Preferably, the mechanical-energy accumulation means (28) comprise a spring (34), which is connected with the proximal strand (22P) and with the distal strand (22D) of the cable so as to be elastically deformable when these strands move relative to each other, between a rest position, towards which it is resiliently biased, and a position in which it accumulates energy.

The present invention relates to a control device intended for a parking brake, and to a parking-brake system fitted with such device.

A control device intended for the parking brake of a vehicle, of the type comprising a cable connecting an operating lever to a disc brake, is already well known from the state of the art.

Quite generally, the disc brake comprises a moving part, comprising the disc driven by the wheel, and a stationary part comprising a caliper, which bears pads fitted with friction linings to be pressed against the disc. The applying of the pads may be controlled, on the one hand, by a hydraulic device taking charge of the braking operation of the vehicle when in motion and, on the other hand, by a mechanical device, used to keep the vehicle at a standstill, when parked. Such mechanical device comprises the cable, connecting the operating lever (generally, a hand-actuated one) to the disc brake.

In some cases, the driver, wanting to stop the vehicle, actuates the operating lever so as to apply a pressure force onto the disc, which is just enough to bring the vehicle to an immediate standstill. Yet, when the disc is pressed upon, it may happen to be hot. On its cooling down, the disc together with the pad linings are subjected to an axial contraction, at the risk of a releasing of the brake if its initial application force is not sufficient to make up for the contraction of the disc and of the linings.

Therefore, an object of this invention consists in avoiding an accidental release of a parking brake of the disc type, more particularly on the cooling down of said disc and of the friction linings, after an application of the brake.

To this end, the invention provides a control device for a parking brake of a vehicle, of the above-mentioned type, characterised in that it comprises mechanical-energy accumulation means, which are separate from the cable and which connect a proximal strand to a distal strand of the cable.

According to other characteristics of said device:

the mechanical-energy accumulation means comprise a spring, which is connected with the proximal strand and with the distal strand of the cable so as to be elastically deformable when these strands move relative to each other, between a rest position, towards which it is resiliently biased, and a position in which it accumulates energy

the spring is prestressed to its rest position

the spring is hooked between first and second connecting members, which are rigidly linked with the proximal and distal strands respectively, and the device comprising limiting means for the relative travel of the connecting members, when the spring becomes deformed between its rest position and its mechanical-energy accumulation position;

when the spring becomes deformed between its rest position and its mechanical-energy accumulation position, the relative travel of the connecting members amounts at least to 2 mm and it ranges, e.g., from 2 to 6 mm;

the first connecting member constitutes a housing, accommodating the spring and the second connecting member;

the spring is a compression one, and it comprises two ends, resting on two respective seats, connected with the proximal and distal strands of the cable, respectively;

the second connecting member comprises a first end and a second end, which are intended to cooperate with a first stop and a second stop, provided on the first connecting member, on the one hand, so as to limit the relative travel of the connecting members when the spring becomes deformed between its rest position and its mechanical-energy accumulation position and, on the other hand, in order to prestress the spring to its rest position;

the first end-of-travel stop consists of a bearing seat for the spring, such seat letting through a strand of the cable.

The invention also deals with a parking-brake system for a vehicle, of the type comprising an assembly consisting of at least one disc brake, characterised in that it comprises a control device for a disc brake as per the above definition.

According to another characteristic of such system, the stiffness of the mechanical-energy accumulation spring is lower than the total stiffness of the assembly comprising at least one disc brake.

Other features and advantages of the present invention will be apparent from the following detailed description, by way of example and by no means as a limitation, when taken in conjunction with the accompanying drawings, in which

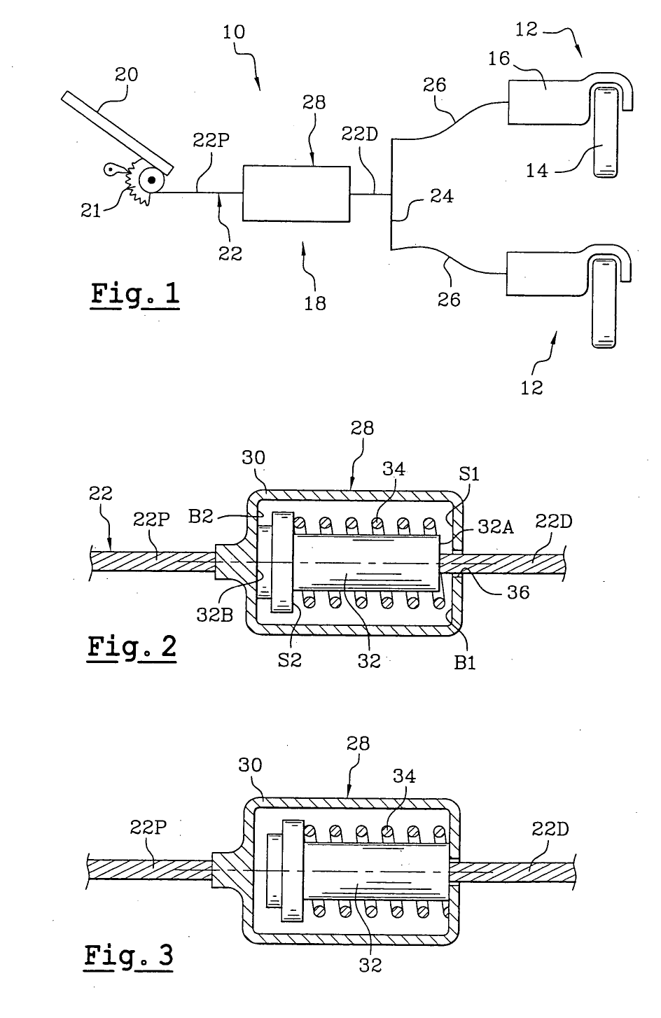

FIG. 1 is a schematic view of a parking-brake system for a vehicle according to this invention

FIGS. 2 and 3 are schematic views of a control device for a parking brake of the system as shown in FIG. 1, such control device being illustrated in a rest position and in an energy-accumulation position respectively

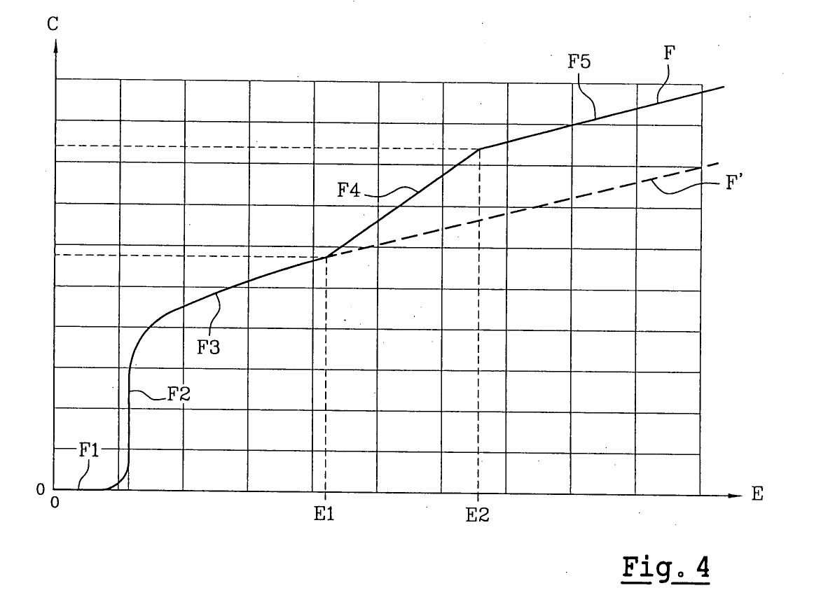

FIG. 4 is a graph in which the travel of the proximal strand of the cable is plotted versus the tensioning force exerted on the cable.

FIG. 1 represents a parking-brake system according to this invention and intended for a vehicle, in particular a motor vehicle, and designated, as a whole, by the reference numeral 10.

Such system 10 comprises at least one disc brake 12, for instance two disc brakes 12, as shown in FIG. 1.

Each brake 12 comprises a moving part, comprising a disc 14 driven by a wheel of the vehicle, and a stationary part comprising a caliper 16. Such caliper 16 is intended to bear conventional pads, fitted with friction linings to be applied onto the disc 14.

Quite conventionally, the applying of the pads may be controlled, on the one hand, by a hydraulic device (not shown) taking charge of the braking operation of the vehicle when in motion and, on the other hand, by a mechanical device 18, used to keep the vehicle at a standstill, when parked.

The system 10 also comprises a conventional operating lever 20, connected to both brakes 12 through the control device 18, as well as locking means 21 of the ratchet type for the operating lever 20.

In the following, an element will be designated as “proximal” when it is situated near the operating lever 20, and an element will be called “distal” when it is remote from the operating lever 20.

The control device 18 comprises a primary cable 22, which is connected to two secondary cables 26 through a conventional coupling member, such as a compensation bar 24. The primary cable 22 and the secondary cables 26 are conventional ones.

The proximal end of the primary cable 22 is connected, in a manner known per se, with the operating lever 20. The distal end of each secondary cable 26 is connected, in a manner known per se too, with a corresponding brake 12.

The control device 18 comprises mechanical-energy accumulation means 28, which are separate from the cables 22 and 26, and which connect, in the described example, a proximal strand 22P to a distal strand 22D of the primary cable 22.

FIGS. 2 and 3 show an embodiment of the mechanical-energy accumulation means 28.

As illustrated, the mechanical-energy accumulation means 28 comprise a first connecting member 30 and a second connecting member 32, which are rigidly linked with a proximal strand 22P and a distal strand 22D of the primary cable, respectively. The first connecting member 30 constitutes a housing, accommodating the second connecting member 32.

The mechanical-energy accumulation means 28 also comprise a spring 34, which is connected with the connecting members 30, 32 so as to be elastically deformable, when the proximal strand 22P and the distal strand 22D of the primary cable move relative to each other, between a rest position, as illustrated in FIG. 2, and an energy-accumulation position, as shown in FIG. 3.

The spring 34 is resiliently biased to its rest position, in which it is prestressed.

In the illustrated example, the spring 34 is a compression spring and it comprises two ends, resting on two respective seats S1, S2 provided on the connecting members 30, 32.

The second connecting member 32, exhibiting a generally cylindrical shape, is surrounded with the spring 34. Such second connecting member 32 comprises a first end 32A and a second end 32B, which are intended to cooperate with a first stop B1 and a second stop B2, provided on the first connecting member 30. The first stop B1, consisting of the bearing seat S1 for the spring, is intended to cooperate with the first end 32A of the second connecting member 32 so as to limit the relative travel of both connecting members 30, 32 when the spring-34 becomes deformed between its rest position (FIG. 2) and its mechanical-energy accumulation position (FIG. 3). The second stop B2 is intended to cooperate with the second end 32B of the second connecting member 32 so as to prestress the spring 34 to its rest position.

When the spring 34 becomes deformed between its rest position and its mechanical-energy accumulation position, the relative travel of the connecting members 30, 32 amounts, in a preferred manner, at least to 2 mm and it ranges, e.g., from 2 to 6 mm.

It should be noted that the bearing seat S1 for the spring 34 has a through-hole 36 for the passage of the distal strand 22D of the primary cable.

When the control device 18 biases a brake 12 to an application position, the various members of the stationary part of the brake 12, and more particularly the caliper 16, undergo an elastic deformation. Thus, a brake is conventionally characterised by a total stiffness, representative of the deformation of the stationary part of the brake when the latter is applied. Such total stiffness is commonly called the “brake stiffness”.

According to the present invention, the stiffness of the spring 34 of the mechanical-energy accumulation means 28 is lower than the total stiffness of the assembly consisting of both brakes 12 parallel-connected to the distal strand 22D of the primary cable (the stiffness values of those parallel-connected brakes are totted up).

FIG. 4 represents the curve F of the travel C (ordinate) of a moving end of the primary cable 22 as a function of the force E (abscissa) applied by the driver on such cable 22, through the operating lever 20.

It should be noted that, when the operating lever 20 is actuated so as to apply the parking brake, the moving end of the primary cable 22 is its proximal end owing to the fact that, at that moment, such end is connected to the operating lever 20 and driven by it, whereas, after the applying of the parking brake, the operating lever 20 is fixed in position, with the result that the moving end of the primary cable 22 is now its distal end (connected to the compensation bar 24), such end being capable of moving because of the cooling down of the discs of the brakes 12, and of the linings of their pads.

As appears from the curve F, taking into consideration an increasing force exerted on the operating lever 20, such curve F exhibits three successive portions F1 to F3, as usual.

The first portion F1 of the curve, which is substantially horizontal, corresponds to the various forces (friction, etc.) which the driver must overcome before a motion of the proximal end of the primary cable 22 is possible.

The second portion F2 of the curve, which is substantially vertical, corresponds to the taking up of the various clearances inside the control device 18.

The third portion F3 of the curve is a general upslope, as set by the stiffness of the assembly consisting of both brakes 12.

Such portion F3 of the curve connects with a fourth portion F4 exhibiting an upslope resulting from the stiffness of the mechanical-energy accumulation means 28. The slope of said fourth portion F4 is steeper than that of the third portion F3 because the stiffness of the spring 34 is lower than the stiffness of the assembly consisting of both brakes 12.

It should be noted that the fourth portion F4 of the curve lies between two values E1, E2 of the force to be exerted on the operating lever. The first force value E1 corresponds substantially to the prestressing of the spring 34, whereas the second force value E2 corresponds substantially to the force required for the movement of the spring 34 towards its energy-accumulation position, as shown in FIG. 3.

The portion F4 connects with a fifth portion F5 of the curve, having a lower gradient than that of the fourth portion F4, owing to the stiffness of the assembly consisting of both brakes 12.

FIG. 4 shows, in broken lines, the portion F′ of the curve which would be obtained if no energy-accumulation means 28 were provided for. As appears from it, the fifth portion F5 of the curve is substantially parallel to that dashed portion F′.

Quite conventionally, when the vehicle is parked on a relatively horizontal ground, the driver actuates the operating lever 20 along a normal path. On the other hand, when the vehicle is parked on a comparatively sloping ground, the driver actuates the operating level 20 along a longer path than the normal one, so as to apply the parking brake still more in order to avoid any accidental movement of the vehicle.

Within the scope of the invention, anyone skilled in the art will be able to choose the values of the points E1 and E2 in such a way that the fourth portion F4 of the curve may correspond to the usual positional range within which the driver is likely to set the operating lever 20 along a normal path, corresponding to a relatively horizontal parking place.

Thanks to the invention, a point, located on the fourth portion F4 of the curve, corresponds to a pressure force exerted on the discs 14 of the brakes 12, which is just enough to bring the vehicle to an immediate standstill on a relatively horizontal ground.

If the parking brake has been applied whereas the discs 14 were still hot, on the cooling down of the latter, the application of the brakes 12 is nevertheless maintained at a constant force thanks to the spring 34 of the mechanical-energy accumulation means 28. As a matter of fact, on the cooling down of the brakes, the axial contractions of the discs 14 and of the pad linings bring about a shifting of the secondary cables 26, which results in some shifting of the distal strand 22D of the primary cable as well. But the shifting of the distal strand 22D of the primary cable is compensated for by the spring 34, since the latter returns some force, thus reducing the variations of the applying force exerted on the brakes 12, although the primary cable 22 is generally shortening.

Therefore, owing to the fact that the brakes 12 remain in the applied state despite the cooling down of the discs 14, there is no risk of an accidental release of the brakes.

Nevertheless, the invention is by no means limited to the above-described embodiment.

And, more particularly, the mechanical-energy accumulation means 28 may be arranged on each one of the secondary cables 26 instead of being provided on the primary cable 22.

Besides, the energy-accumulation means 28 may be fitted with springs of various types, for instance a compression spring as per this embodiment, a tension spring or an angular-effect spring. The spring may be chosen from various shapes: it may exhibit a single- or multiple-helical form, a single- or multiple-conical one, it may also be a barrel-shaped spring, a leaf spring or a ring-shaped one.

Furthermore, although the control device 18 acts on two disc brakes in the illustrated embodiment, the invention may be applied, in the same way, to the control of one disc brake only, or to more than two disc brakes, e.g. four brakes.

It should be noted that, among the numerous advantages of the invention, the latter makes it possible to prevent an accidental release of a parking brake of the disc type, more especially on the cooling down of such disc after a brake application.

The increase of the travel range of the operating lever 20 so as to move the spring 34 between its rest position and its energy-accumulation position, is limited and predetermined.

Since the relative travel of the connecting members 30, 32 is limited, and owing to the fact that the spring 34 is most advantageously protected by a housing-forming connecting member 30, there is no risk of its being excessively compressed.

I claim:

1. A control device intended for a parking brake of a vehicle, of the type comprising a cable (22) connecting an operating lever (20) to a disc brake (12), mechanical-energy accumulation means (28), which are separate from the cable (22) and which connect a proximal strand (22P) to a distal strand (22D) of the cable, said mechanical-energy accumulation means comprising a spring (34), which is connected with the proximal strand (22P) and with the distal strand (22D) of the cable so as to be elastically deformable when these strands move relative to each other, between a rest position, towards which it is resiliently biased, and a position in which it accumulates energy, characterised in that the stiffness of the spring (34) of the energy-accumulation means (28) is lower than the total stiffness of the assembly consisting of the two brakes (12), which are parallel-connected to the distal strand (22D) of the primary cable.

2. The device according to claim 1, characterised in that the spring (34) is prestressed to its rest position.

3. The device according to claim 2, characterised in that the spring is hooked between first and second connecting members (30, 32), which are rigidly linked with the proximal strand (22P) and the distal strand (22D) respectively, the device comprising limiting means (32A, B1) for the relative travel of the connecting members (30, 32) when the spring (34) becomes deformed between its rest position and its mechanical-energy accumulation position.

4. The device according to claim 3, characterised in that, when the spring (34) becomes deformed between its rest position and its mechanical-energy accumulation position, the relative travel of the connecting members (30, 32) amounts at least to 2 mm.

5. The device according to claim 3, characterised in that, when the spring (34) becomes deformed between its rest position and its mechanical-energy accumulation position, the relative travel of the connecting members (30, 32) ranges from 2 to 6 mm.

6. The device according to claim 5, characterised in that the first connecting member (30) constitutes a housing, accommodating the spring (34) and the second connecting member (32).

7. The device according to claim 6, characterised in that the spring (34) is a compression one, and in that it comprises two ends, resting on two seats (S1, S2) respectively, and connected with the proximal strand (22P) and with the distal strand (22D) of the cable, respectively.

8. Th device according to claim 7, characterised in that the second connecting member (32) comprises a first end (32A) and a second end (32B), which are intended to cooperate with a first stop (B1) and a second stop (B2), provided on the first connecting member (30), on the one hand, so as to limit the relative travel of the connecting members (30, 32) when the spring (34) becomes deformed between its rest position and its mechanical-energy accumulation position and, on the other hand, in order to prestress the spring (34) to its rest position.

9. The device according to claim 8, characterised in that the first end-of-travel stop (B1) consists of a bearing seat (S1) for the spring, such seat letting through a strand (22D) of the cable.

10. The device according to claim 11 for use in a disc brake (12) for a parking brake system for a vehicle.

11. The device according to claim 10, comprising a control device (18) according to claim 9, characterised in that the stiffness of the mechanical-energy accumulation spring (34) is lower than the total stiffness of the assembly comprising at least one disc brake (12).
